(19) United States
(12) Patent Application Publication
(10) Pub. No.: US 2003/0185569 A1
(43) Pub. Date: Oct. 2, 2003

(54) Optical communication module for demultiplexing wavelength division multiplexed light

(76) Inventors: Hisao Nagata, Osaka (JP); Masahiro Oikawa, Osaka (JP)

Correspondence Address: RATNERPRESTIA, P O BOX 980, VALLEY FORGE, PA, 19482-0980, US

(21) Appl. No.: 10/397,548

(22) Filed: Mar. 26, 2003

(30) Foreign Application Priority Data
Mar. 27, 2002 (JP) 2002-88,464

(51) Int. Cl. H04J 14/02

(52) U.S. Cl. 398/84; 398/79

(57) ABSTRACT

Disclosed is an optical communication module which may have a broad bandwidth by faithfully deriving a signal from an optical demultiplexer to obtain a flat-top in the frequency spectrum of the signal. The optical communication module comprises an optical demultiplexing component for demultiplexing the high-speed modulated and wavelength division multiplexed light, and a photoelectric transfer element array directly and optically coupled to the optical demultiplexing component. The optical demultiplexing component demultiplexes the light and emanates the demultiplexed light. Each demultiplexed light is impinged upon a corresponding photoelectric transfer element of the array. The photoelectric transfer element converges the demultiplexed light into an electrical signal.

### BACKGROUND OF THE INVENTION

1. Field of the Invention

The present invention relates to an optical communication module, particularly to an optical communication module suitable for a high-speed modulation and wavelength division multiplexing communication.

2. Description of the Prior Art

In an optical communication, an expansion of the number of wavelengths for a wavelength division multiplexing communication and an enlargement of a data transmitting capacity due to a high-speed optical signals through respective channels have been implemented. The enlargement of a data communication capacity of an optical communication has accelerated a development for components thereof. The present development target has been directed to an apparatus or system corresponding to a frequency interval of 50 GHz and a modulation speed (or a transmission speed) of 40 Gbits/second (Gbps), resulting in a decrease of the frequency interval and an increase of the modulation speed.

While a modulation speed is typically indicated as 40 Gbps herein, it is precisely 39.81312 Gbps in the OC (Optical Carrier)−768 [STM (Synchronous Transport Module)−64] Standard, or 43.018 Gbps when a signal for Forward Error Check is added.

An optical demultiplexing component utilizing a bulk diffraction grating has been known as one of optical components for separating multiplexed waves (or wavelength division multiplexed light). Such an optical demultiplexing component is illustrated in FIG. 1. As shown in the figure, wavelength division multiplexed light 4 (for example, waves of wavelengths λ1, λ2, λ3 and λ4 are multiplexed) emanating from an optical fiber 2 is converted into collimated light 8 by means of a lens 6 and impinged upon a bulk diffraction grating 10. The diffracted light 12 is launched from the diffraction grating 10 in directions determined by a groove spacing of the diffraction grating, an incident angle of the collimated light, and the wavelengths of the waves included in the light. Each diffracted light is converged by means of a lens 14 to impinge upon corresponding optical fibers 16-1, 16-2, 16-3 and 16-4, respectively. The waves of wavelengths λ1, λ2, λ3 and λ4 are emanated from the respective optical fibers.

In an optical communication module which is an optical demultiplexer using the optical demultiplexing component described above, the light emanated from each of the optical fibers is conducted to a photoelectric transfer element array (not shown) to convert the light into an electrical signal.

An arrayed waveguide (AWG) diffraction grating is known as one of optical demultiplexers for separating wavelength division multiplexed light (see U.S. Pat. Nos. 5,002,350 and 5,136,671, and Japanese Patent No. 2599786). The descriptions set forth in the U.S. patents are hereby incorporated into the present application by this reference.

The arrayed waveguide diffraction grating comprises, as shown in FIG. 2, one input optical waveguide 22, a first slab waveguide 24, an arrayed waveguide 26 consisting of a plurality of channel waveguides arrayed in parallel and having different lengths one another, a second slab waveguide 28, and a plurality of output optical waveguides 30, formed on a substrate 20. The wavelength division multiplexed light including the waves of wavelengths λ1, λ2, λ3, λ4 and λ5 is impinged upon the optical input waveguide 22, and then the light of corresponding wave is emanated from the output optical waveguides 30, respectively.

In an optical communication module which is an optical demultiplexer using the optical demultiplexing component described above, the light emanated from each of the-output optical waveguides of the array is conducted to an photoelectric transfer element array (not shown) to convert the light into an electrical signal.

In two prior arts described above, the demultiplexed light is conducted to an photoelectric transfer element array through optical fibers or optical waveguides. The prior arts described above, therefore, have had the following problems.

A high-speed modulated and wavelength division multiplexed signal has sidebands due to the modulation, the sidebands being spread on both sides of a carrier light signal and being repeated due to the wavelength division multiplexing. The frequency spectrum of a signal obtained by modulating a carrier light signal in 10 Gbps has a 12 GHz width, but the frequency spectrum is spread to a 50 GHz width when a carrier light signal is modulated in 40 Gbps. In the case of frequency division multiplexing communication of 50 GHz intervals (modulated in 40 Gbps), an interval of frequency spectra is extremely narrowed. Consequently, it is not easy even in 100 GHz intervals to handle a signal modulated in 40 Gbps.

It should be noted that the above-described 10 Gbps is precisely 9.95328 Mbps according to OC-192 (STM-64) Standard, or 10.709 Gbps when a signal for Forward Error Check is added.

Referring to FIG. 3, there is shown the frequency spectra of demultiplexed waves prior to conducted to the optical fibers 16 or optical waveguides 30 in the optical demultiplexing components shown in FIG. 1 or 2. When a high-speed modulated and wavelength division multiplexed light (including the waves of wavelength λ1, λ2, λ3, λ4 and λ5) is input to an optical demultiplexing component 40 and is demultiplexed therein, the position on which each demultiplexed light is focused by means of the lens 14 or slab waveguide 28 is depend on the wavelength thereof. According to the frequency spectrum of each demultiplexed light (each wavelength thereof is λ1, λ2, λ3, λ4 or λ5), it is appreciated that sidebands S due to the modulation are spread on both sides of the carrier light signal C in each demultiplexed light.

Referring to FIG. 4, there is shown how the spectrum of each demultiplexed light is varied after the light passes through the optical fiber or optical waveguide. When the output light (wavelengths λ1, λ2, λ3, λ4 and λ5) from the light demultiplexing component 40 is coupled to the optical fibers or waveguides 42 and passes through it, a part of sidebands S is suppressed due to the mode field of the optical fiber or waveguide itself. In other words, when the demultiplexed light passes through the optical fiber or waveguide, a flat-top in the frequency spectrum may not be obtained, thereby giving a distortion to a light signal. As a result, an effective bandwidth of a light signal becomes narrower, even if the bandwidth of the optical demultiplexing component 40 itself is broad.

An optical fiber for a light communication has a core of about 8 μm in diameter and a clad of 250 μm in diameter, for example. It is assumed that a light signal which is wavelength division multiplexed in 100 GHz intervals, for example, is demultiplexed by means of an optical demultiplexing component, and the resulting optical demultiplexed light signal is coupled to a fiber array consisting of a plurality of said optical fibers. Considering the ratio of the diameters of core and clad with ignoring a mode spread, a signal only having a width of 3.2 GHz may be coupled to the core of the optical fiber. This means that it is not easy to handle a signal demodulated in 10 Gbps.

On the other hand, if an optical waveguide array is used on the output side of the optical demultiplexing component, the ratio of the diameters of waveguide and clad may be selected so as to be larger than the ratio of the diameters of core and clad of an optical fiber. However, an interval between neighboring waveguides is narrowed or a width of the waveguide is broadened, resulting in the enlargement of crosstalk between neighboring channels due to the coupling of wave guiding modes, the decrease of coupling efficiency, and the increase of deflection dependency (PDL).

### SUMMARY OF THE INVENTION

The object of the present invention is to provide an optical communication module which may have a broad bandwidth by faithfully deriving a signal from an optical demultiplexer to obtain a flat-top in the frequency spectrum of the signal.

According to the present invention, the light demultiplexed by means of an optical demultiplexing component is directly received by means of a photoelectric transfer element array without using an optical fiber array or optical waveguide array on an output side of the optical communication module. A photoelectric transfer element such as a photodiode has a sensitivity distribution which is uniform in space, which is extremely small compared with that of an optical fiber. Therefore, the photoelectric transfer element may obtain a flat-top in the frequency spectrum in combination with the optical demultiplexing component, and the decrease of bandwidth due to the coupling by means of an optical fiber or optical guidewave may be prevented.

The present invention is directed to an optical communication module for demultiplexing a high-speed modulated and wavelength division multiplexed light and converting each demultiplexed light into an electrical signal. The optical communication module comprises an optical demultiplexing component for demultiplexing the high-speed modulated and wavelength division multiplexed light, and a photoelectric transfer element array directly and optically coupled to the optical demultiplexing component for converting each demultiplexed light into an electrical signal.

A bulk diffraction grating or arrayed waveguide diffraction grating is preferably used for the optical demultiplexing component. It is also preferable that the photoelectric transfer element array is a photodiode array.

### BRIEF DESCRIPTION OF THE DRAWINGS

FIG. 1 shows a conventional optical demultiplexing component using a bulk diffraction grating.

FIG. 2 shows a conventional optical demultiplexing component using an arrayed waveguide diffraction grating.

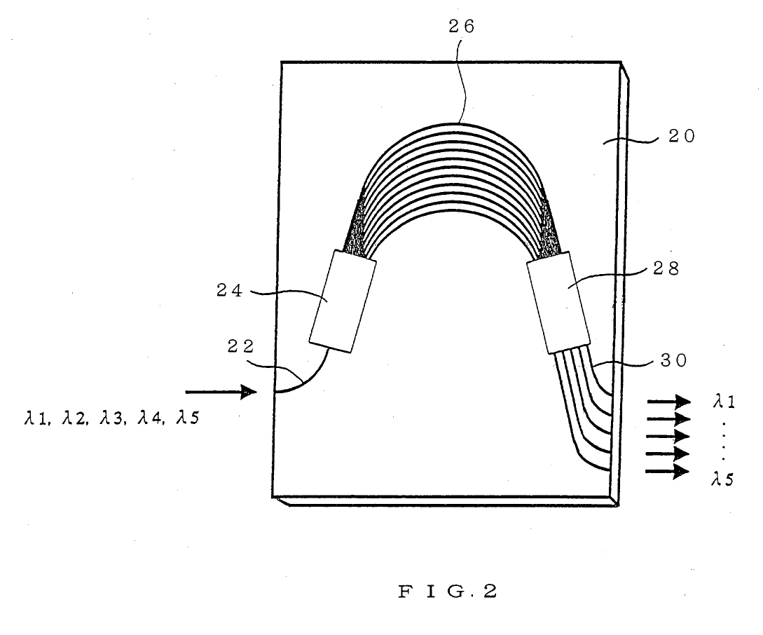

FIG. 3 shows the spread of sidebands S on both sides of a carrier light C of each wave.

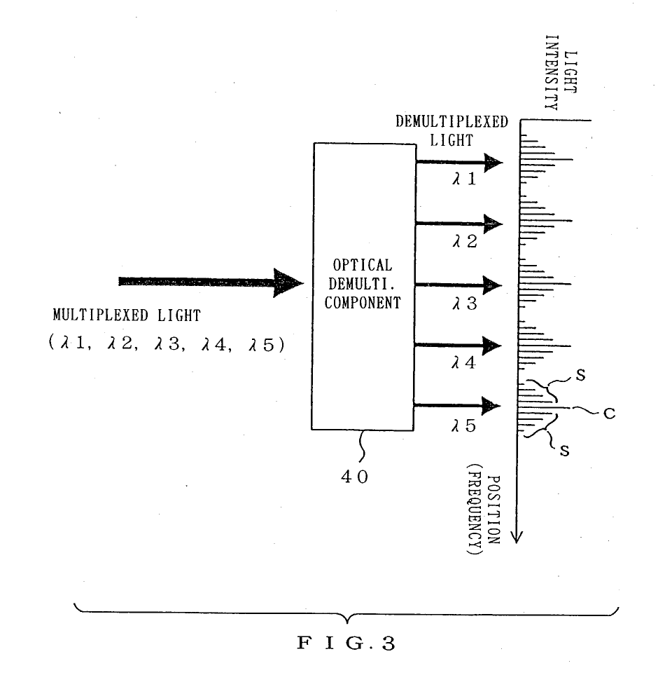

FIG. 4 shows a conventional optical communication module.

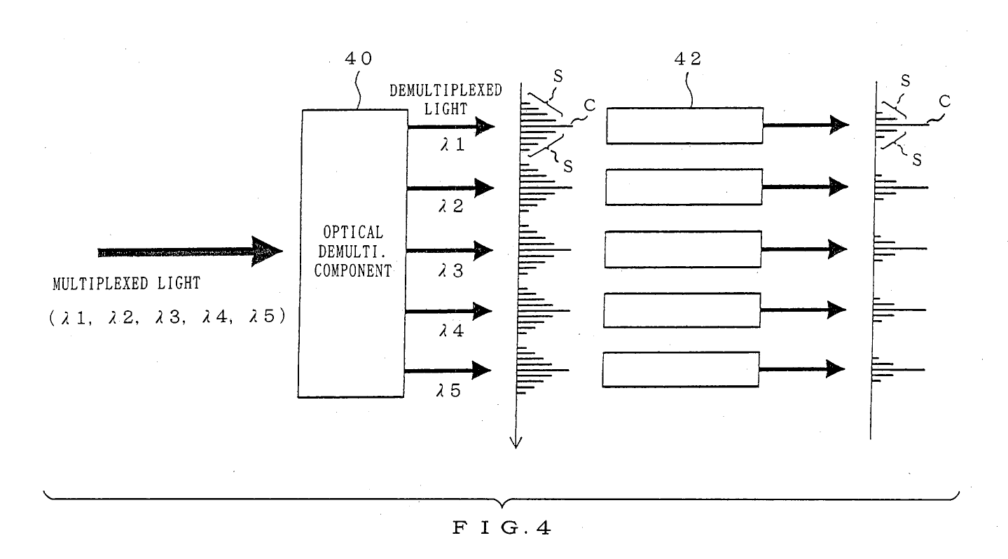

FIG. 5 shows the fundamental structure of an optical communication module according to the present invention.

FIG. 6 shows a first embodiment of an optical communication module according to the present invention using an arrayed waveguide diffraction grating.

FIG. 7 shows a waveform division characteristic of the optical communication module in FIG. 6.

FIG. 8 shows the relation between a frequency spectrum and an eye pattern.

FIG. 9 shows a second embodiment of an optical communication module according to the present invention using a bulk diffraction grating.

### DESCRIPTION OF THE EXEMPLARY EMBODIMENT

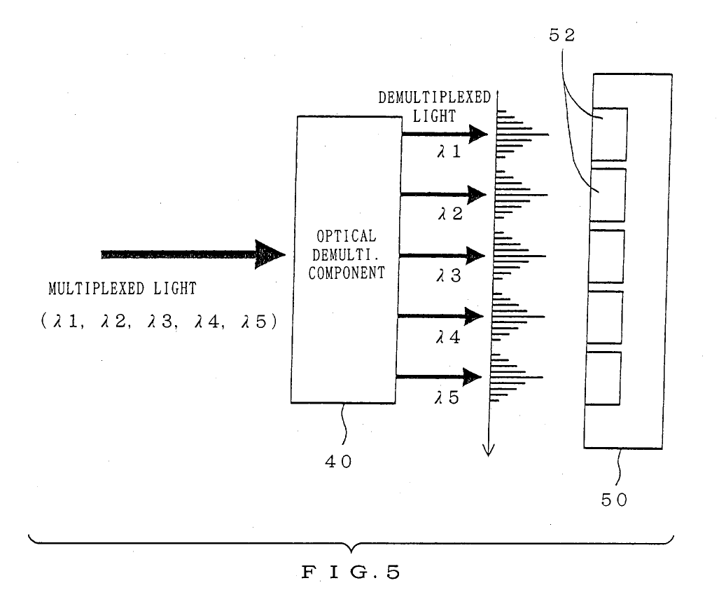

Referring to FIG. 5, there is shown the fundamental structure of an optical communication module according to the present invention. The optical communication module comprises an optical demultiplexing component 40 for demultiplexing a high-speed modulated and wavelength division multiplexed light, and a photoelectric transfer element array 50 for directly receiving the light demultiplexed by means of the component 40.

A high-speed modulated and wavelength division multiplexed light is impinged upon the optical demultiplexing component 40. It is assumed that the incident light includes multiplexed waves the frequency interval thereof is at most 100 GHz and the modulation speed thereof is at least 2 Gbps.

The optical demultiplexing component 40 demultiplexes the incident light and emanates the demultiplexed light. Each demultiplexed light is impinged upon the corresponding photoelectric transfer element 52 of the array 50. Each photoelectric transfer element converts the demultiplexed light into an electrical signal.

The photoelectric transfer element has a sensitivity distribution which is uniform in space, which is extremely small compared with that of an optical fiber, so that the photoelectric transfer element may obtain a flat-top in the frequency spectrum in combination with the optical demultiplexing component.

First Embodiment

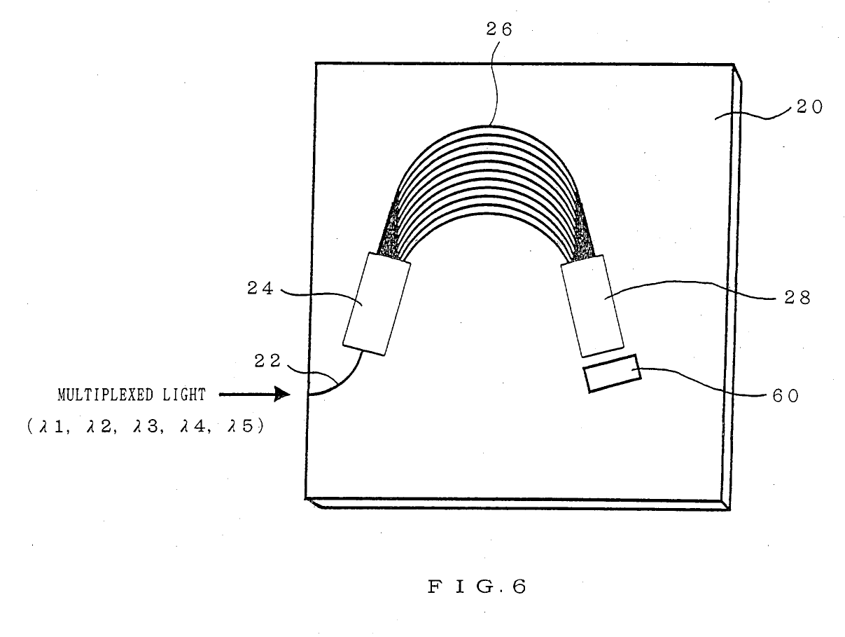

Referring to FIG. 6, there is shown an embodiment of an optical communication module according to the present invention using an arrayed waveguide diffraction grating. The arrayed waveguide diffraction grating comprises one input optical waveguide 22, a first slab waveguide 24, an arrayed waveguide (AWG) 26 consisting of a plurality of channel waveguides arrayed in parallel and having different lengths one another, a second slab waveguide 28, and a plurality of output optical waveguides 30, formed on a substrate 20. The arrayed waveguide diffraction grating is designed so that an optical demultiplexing is functioned in a frequency interval of 100 GHz.

In the optical communication module according to the present embodiment, a photodiode (PD) array 60 is aligned and fixed to the opposite end of the second slab waveguide 28. The photodiode array 60 is designed for the modulation in 2.5 Gbps. Also, the photodiode array 60 is a bottom-surface incident type and comprises a plurality of light-receiving areas arrayed in 5 μm interval, each area having a width of 15 m.

While a modulation speed is typically indicated as 2.5 Gbps herein, the optical communication using this modulation speed corresponds to the OC-48 of SONET (Synchronized Optical Network), or STM-16 of SDH (Synchronous Digital Hierarchy), and then the precise modulation speed is 2.48832 Gbps.

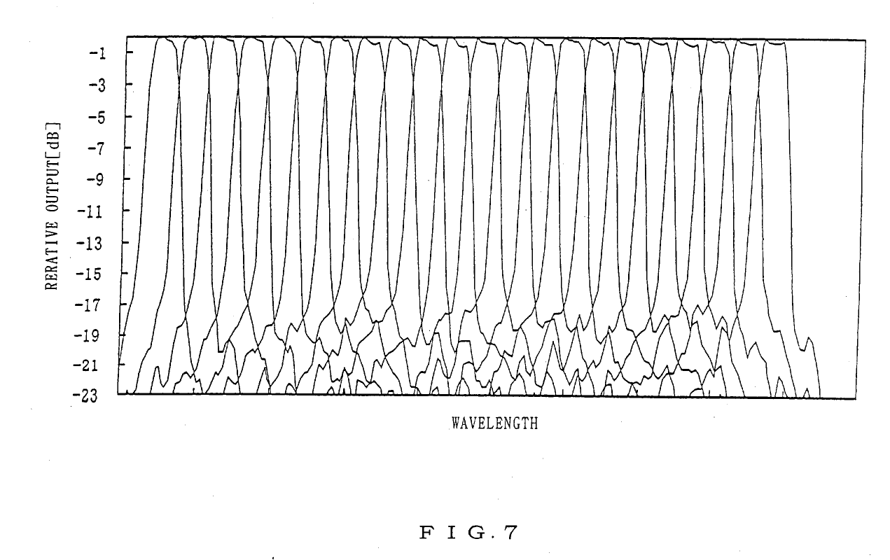

Referring to FIG. 7, there is shown a wavelength division characteristic of this optical communication module. In the figure, the electric signal outputs for demultiplexed light are plotted. The flat-top defined at 1 dB peak corresponds to 78% of a peak interval, i.e. the flat-top has a broad bandwidth of 78 GHz.

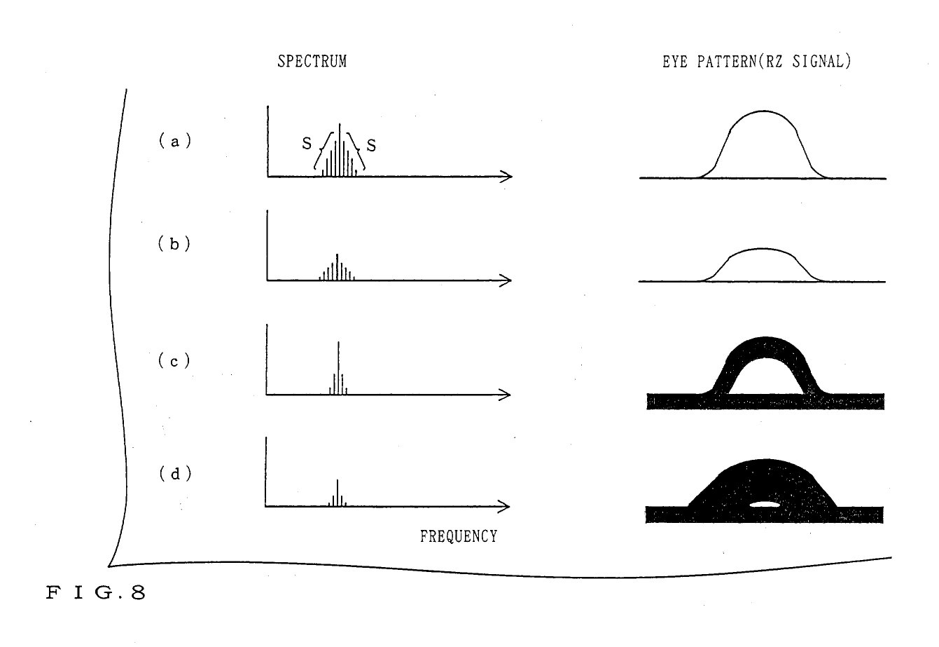

Referring to FIG. 8, there is shown the relation between a frequency spectrum and an eye pattern (when Return to Zero (RZ) signal is received) for demultiplexed light. A frequency spectrum is illustrated on left side, and an eye pattern on right side.

The relation (a) is for the case of ideal demultiplexed light, (b) for the case of demultiplexed light including a loss, (c) for the case of demultiplexed light having a narrow bandwidth, and (d) for the case of demultiplexed light having a narrow bandwidth and including a loss, respectively.

As shown in the relation (a), the ideal demultiplexed light is a signal without a distortion for the sidebands S, and the eye pattern has an enough width. As shown in the relation (b), the multiplexed light having a loss affects not a width of the eye pattern, but a height thereof. As shown in the relation (c), the sidebands of the demultiplexed light having a narrow bandwidth is distorted, and the eye pattern becomes small. As shown in the relation (d), an eye in the pattern is disappeared for the demultiplexed light having a narrow bandwidth and including a loss.

Because the PD array 40 used in the present embodiment has a design for the modulation in 2.5 Gbps, the demultiplexing characteristic of an optical signal demodulated in 2.5 Gbps has been evaluated. It has been understood that there are no problems for an eye pattern.

Second Embodiment

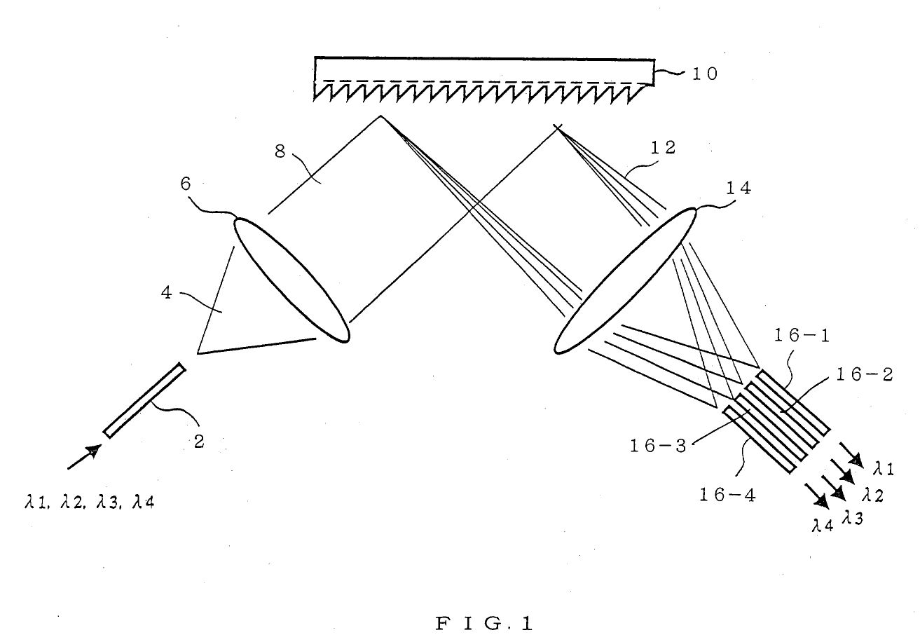

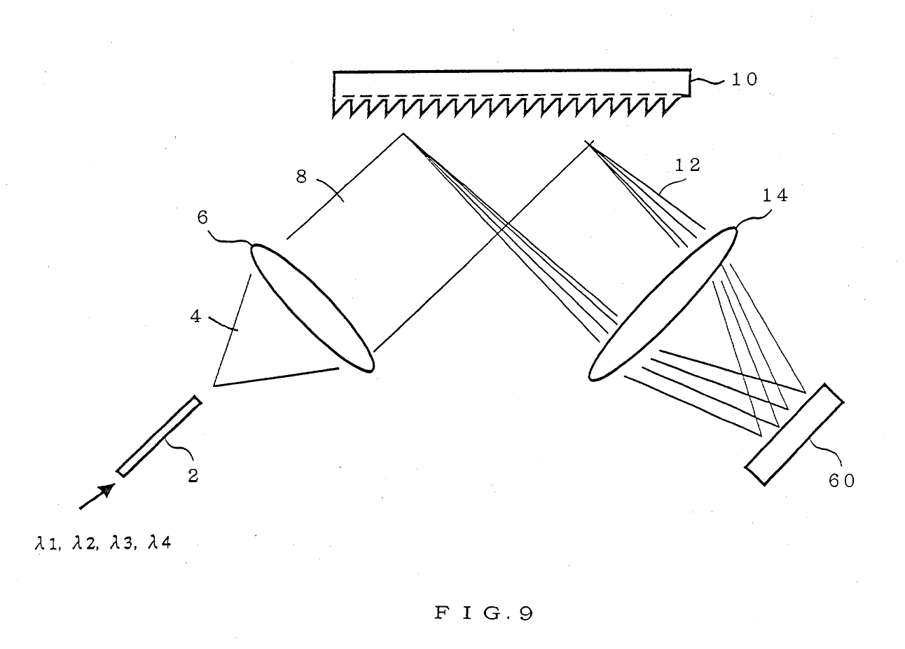

Referring to FIG. 9, there is shown an embodiment of an optical communication module according to the present invention using a bulk diffraction grating. The optical communication module comprises a photodiode array 60 provided on a light emanating side of the lens 14 shown in FIG. 1. Likewise in the first embodiment, a wavelength division multiplexed light is used, the frequency interval thereof is 100 GHz and the modulation speed thereof is 2.5 Gbps. When the wavelength division multiplexed light 4 (for example, waves of wavelengths λ1, λ2, λ3 and λ4 are multiplexed) emanating from an optical fiber 2 is converted into collimated light 8 by means of a lens 6 and impinged upon a bulk diffraction grating 10, the diffracted light 12 is launched from the diffraction grating 10 in directions determined by a groove spacing of the diffraction grating, an incident angle of the collimated light, and the wavelengths of the waves included in the light. Each diffracted light is converged into the photodiode array 60 by means of a lens 14. The photodiode array 60 converts each diffracted light into an electrical signal.

Likewise in the first embodiment, a broad bandwidth flat-top has been realized and an eye pattern which shows an ideal demultiplexed light has been confirmed.

An example of wavelength division multiplexed light having a frequency interval of 100 GHz and a modulation speed of 2.5 Gbps has been illustrated. As to wavelength division multiplexed light having a frequency interval of 100 GHz and a modulation speed of 10 Gbps, a broad bandwidth flat-top has also been realized and an eye pattern which shows an ideal demultiplexed light has also been confirmed.

It is easily understood for those who skilled in the art that the optical communication module according to the present invention may be applicable to wavelength division multiplexed light having a frequency interval of 50 GHz and a modulation speed of 40 Gbps.

According to the present invention, an optical communication module may be implemented in which a broad bandwidth flat-top may be realized and the decrease of bandwidth due to the coupling by means of an optical fiber or optical guidewave may be prevented, because the high-speed modulated and wavelength division multiplexed light is demultiplexed by an optical demultiplexing component and the demultiplexed light is directly received by means of a photoelectric transfer element array.

What is claimed is:

1. An optical communication module for demultiplexing a high-speed modulated and wavelength division multiplexed light and converting each demultiplexed light into an electrical signal, comprising:
an optical demultiplexing component for demultiplexing the high-speed modulated and wavelength division multiplexed light; and
a photoelectric transfer element array directly and optically coupled to the optical demultiplexing component for converting each demultiplexed light into an electrical signal.

2. The optical communication module of claim 1, wherein the optical demultiplexing component includes at least a bulk diffraction grating.

3. The optical communication module of claim 1, wherein the optical demultiplexing component includes,
a first lens for collimating the high-speed modulated and wavelength division multiplexed light,
a bulk diffraction grating for diffracting the collimated light, and
a second lens for converging the diffracted light into the photoelectric transfer element array.

4. The optical communication module of claim 3, wherein the photoelectric transfer element array receives the light converged by means of the second lens.

5. The optical communication module of claim 1, wherein the optical demultiplexing component includes an arrayed waveguide diffraction grating.

6. The optical communication module of claim 5, wherein the arrayed waveguide diffraction grating includes,
an input optical waveguide for guiding the high-speed modulated and wavelength division multiplexed light,
a first slab waveguide coupled to the input optical waveguide,
an arrayed waveguide, coupled to the first slab waveguide, consisting of a plurality of channel waveguides arrayed in parallel and having different lengths one another, and
a second slab waveguide coupled to the arrayed waveguide,
wherein the first input waveguide, the first slab waveguide, the arrayed waveguide, and the second slab waveguide are formed on a substrate.

7. The optical communication module of claim 6, wherein the photoelectric transfer element array is formed on the substrate.

8. The optical communication module of any one of claims 1-6, wherein the photoelectric transfer element array is a photodiode array.
